(19) United States
(12) Patent Application Publication
(10) Pub. No.: US 2010/0305385 A1
(43) Pub. Date: Dec. 2, 2010

(54) Decontamination of sediments through surface charge modification and encapsulation

(76) Inventor: Yun-Feng Chang, Houston, TX (US)

Correspondence Address: YUN-FENG CHANG, 4443 STERLING WOOD WAY, HOUSTON, TX, 77059, US

(21) Appl. No.: 12/454,824

(22) Filed: May 26, 2009

(51) Int. Cl. A62D 3/00; B32B 1/00; B05D 7/00

(52) U.S. Cl. 588/300; 428/403; 427/212

(57) ABSTRACT

Composition and process of encapsulation of sediment particles to reduce active pollutant components through surface charge modification.

### FIELD OF THE INVENTION

The present invention provides a composition and a process for forming a mixture of sediment, and more particularly to a process for forming a mixture of sediment particle herein the contaminant particle is selectively encapsulated by another charge particle, thus reducing the extracting, leaching or release of the contaminant because of the formed barrier layer.

### BACKGROUND OF THE INVENTION

Improvement in quality of life of many parts of world goes beyond basic needs, for instance, food, water and shelter. People become more and more concerned about the quality of environment they live in. Visible and easily recognizable pollutions, like smog, haze, dust, noise, odor, toxic wastes are highly regulated and monitored. However, some other form of pollutions, for instance, high levels of metals, particularly, heavy metals in sediments and soils have not received equal attentions as those mentioned above. Impact of these less visible or recognizable pollutants is far more reaching and detrimental to the health and quality of life of people live close by sites where they are located. There are a large number of these sites that are not only substantial in size, but also in terms of extent of pollution, close proximity to community and the toxicity of the pollutants. Among the most concerned elements are, for example, mercury and arsenic because of their high toxicity. Treatment of these sites is mandated by local government or state government in many parts of world to reduce or eliminate the negative impact. Therefore, there is strong demand of technologies or methodologies to achieve economic treatment of polluted soils and sediments.

### DESCRIPTION OF THE INVENTION

The present invention enables treating massive pollution sites by achieving high treatment efficiency (reduction in active pollution form) that is unmatched by prior arts. It is achieved through the use of encapsulation agent. The encapsulation is accomplished by (1) electronstatic interaction; (2) chemical bonding; (3) hydrogen bonding; (4) selective adsorption.

“Sediments” refer to materials collected at the subsurface of a waste water containment pond, reservoir, or site. They consist of solids waste present in the waste water stream, or materials formed due to change of temperature, pH, concentration of ionic species, and composition, or introduction of certain solid particles, or reaction of soluble species from different stream or from the same steam but formed at different time. Sedimentation occurs on the time scale of hours, days, sometimes, weeks, months, even years depending on concentration, size of particles and composition of the species present in the system. Presence of multi-valent cations and anions, for example Al³⁺, Ca²⁺, SO₄²⁻, S²⁻, PO₄³⁻ could result in accelerated sedimentation. Introduction of solids particles can also lead to significant enhancement in sedimentation, for example, dust particles fallen into the waste stream or water body, debris of plants, or residue of animal or insects, soil particles, clay, silt, or sludge. Introduction of high molecular weight organics and colloidal particles both charged and non-charged can also result in significant changes in formation of sediments. Thickness and density of sediment layer varies with waster stream composition, change of temperature, solids content and presence of other sedimentation active species. Higher solids content and fast settling rate can lead to denser sediment layer while slow sedimentation and low solids content tend to give lower density of sediment layer. Sediment layer thickness varies from fraction of an inch to inches and even feet depending on the duration of sedimentation and solids content of waste water stream.

“Waste water stream” refers to any water stream that contains undesirable components either soluble or non-soluble, both organic and inorganic. Waste water stream can be produced from chemical plants, petrochemical plants, paper making, food industry, pharmaceutical industry, leather processing, pigment industry, caustic plants, mining operation or processing, and semiconductor industry. Types of contamination can be classified into (1) heavy metals or toxic elements, for example, mercury, cadmium, chromium, antimony, manganese, arsenic, selenium, silver, zinc, copper; (2) carcinogens, polynuclear aromatics (PNA), organochlorides, particularly, multi-chlorinated benzenes or bi-phenyls; (3) fine particles that are toxic. The fine solid particles can be inorganic or organic or combination of both. Due to their small size and high surface area and their affinity to smaller molecules or ionic species, they act as the carrier of many harmful compounds or components. Concentration of heavy elements varies from a fraction of weight part per million (ppm) to hundreds and sometimes a few thousands of part per million. Organic contents vary from many ppm to a few percentage point of the total sediment.

“Particles” refer to materials carried in waste water stream, participation or settlement of particles newly formed from the corresponding soluble species, or agglomeration, assembly of smaller particles, adsorption of soluble species onto particles to make the original particles bigger or make agglomeration or reorganization easier. Particle size ranges from tens of nanometers to microns, even to millimeters. Some debris can be in centimeters. Particle size distribution (PSD) describes the relative proportion of individual particle size. For sedimentation samples, it often refers materials based on their particle sizes as sand, silt and clay, sand is the largest particles, 0.05-2.0 mm, silt is intermediate in size, 0.002-0.05 mm (2-50 microns), while clay is the smallest, <0.002 mm (<2 microns), particles greater than 2.0 mm are generally called stones, rocks, gravels, are not regarded as soil materials. Particles smaller than one micron are also called colloidal particles. Brownian motion is a characteristics of a colloidal particle and the size range is 1 nm to 100 nm, while others have defined colloidal particles being in the range from 5 nm to 500 nm (see J-E. Otterstedt and D. A. Brandreth, Small Particles Technology, Plenum Press, New York, 1998, p. 8). Particles above 500 nm or 0.5 micron in size settle from water in a matter of days, but if they are less than 70 nm, they do not settle under gravity because of Brownian motion that keeps them in suspension.

“Particle size or particle size distribution (PSD)” are obtained by commonly known techniques like (1) sedigraph, for example, Micromeritics SediGraph 5000E, SediGraph 5100 based on particle sedimentation measured by x-ray, it measures particles in the range of 0.5-250 microns; (2) laser scattering, which measures light scattering by particles, particularly small particles, for example, Horiba LA910, Microtrac S3500, measuring particles in the range of 10 nm to 3000 microns; (3) acoustic and electro-acoustic techniques, for example, Matec AZR-Plus or Zeta-APS measuring particles from 10 nm to 100 microns; and Dispersion Technologies DT-1200, measuring particles in the range of 30 nm to 300 microns; (4) ultracentrifugation, in particular, disc centrifuge, for example CPS Instruments DC2400, measuring particles from 5 nm to 75 microns; (5) electroresistance counting method, an example of this is the Coulter counter, which measures the momentary changes in the conductivity of a liquid passing through an orifice that take place when individual non-conducting particles pass through. The particle count is obtained by counting pulses, and the size is dependent on the size of each pulse; (6) high sensitivity electrophoretic laser scattering technique, like Brookhaven Instruments ZetaPals and ZetaPlus, measuring particles of 10 nm to 10 microns; (7) electron microscopic imaging, scanning electron microscopy (SEM) and transmission electron microscopy (TEM); (8) optical microscopy. For a given sample, particle sizes may range from a few nanometers to a few millimeters. Often time, more than one technique is required to get the full distribution. More comprehensive dealing of particle size measurements using light scattering can reference the book, “Particle Characterization: Light Scattering Method”, by Renliang Xu, Kluwer Academic Publisher, Dordrecht, The Netherlands, 2000. More generic treaty of fine particles characterization can reference monograph “Analytical Methods in Fine Particle Technology”, by P. A. Webb and C. Orr, Micromeritics Instrument Corp., Norcross, Ga. Further reference on particle characterization and preparation can be found in the book by J-E. Otterstedt and D. A. Brandreth, “Small Particles Technology”, Plenum Press, New York, 1998; and book by A. M. Spasic and J-P. Hsu, “Finely Dispersed Particles: Micro-, Nano-, and Atto-Engineering”, Taylor & Francis, Roca Raton, 2006.

The “dₛ” particle size for purposes of this patent application and appended claims means that s percent by volume of the sediment particles have a particle diameter no greater than the dₛ value. The “median particle diameter” is the d₅₀ value for a specified plurality of sediment particles.

“Particle diameter” as used herein means the diameter of a specified spherical particle or the equivalent diameter of non-spherical particles as measured by laser scattering using for example, a Brookhaven ZetaPlus, or Microtrac Model S3500 particles size analyzer or by disc centrifuge technique using CPS Instruments DC24000.

“Decontamination” herein is referred to reduction in degree of negative impact caused by active pollutants present in the contaminated treating targets. It is achieved by reduction or elimination of active polluting form through transformation or chemical reaction to convert from an active form to an inactive form. It differs from other remediation techniques like, physical separation or containment. In the latter case, pollutants are not removed or transformed but rather stay intact. The containment provides a physical isolation and a barrier that reduce the immediate impact of the pollution. However, the toxic materials remain a source of pollution, and possess long term risk, from breakdown of the containment or physical barrier or any sabotage.

“Active pollutant form” is referred to forms of a pollutant that is determined by a protocol that is established or published by a local or state or federal government agency. This protocol allows quantification of amount of a given pollutant in samples obtained from a contaminated site. The sample can be in the form of liquid, solid or gas, sometimes, a combination of two or more than two. Quantity of the active pollutant form determined by the protocol is used to evaluate degree of pollution, and extent of decontamination when a treatment is carried out.

One such protocol is given in Table 1. It calls for an extraction procedure to determine the amount of element (pollutant) that is effective in causing harm in sediment samples. This amount is different from the total quantity of such element. For example, if a sample contains 100 ppm of element X in the form of active or extractable form, upon decontamination treatment, it reduces the amount of the active form or extractable form to 50 ppm while the total amount remains the same, then the treatment has achieved a 50% decontamination efficacy. If treatment Y is more effective in decontamination than treatment Z, then Y should give a higher decontamination efficacy than treatment Y. Likewise, two contaminant sites, M and N, both have the same levels of contaminants, or the same total amount of element L, but M has M′ amount of active L, and N has N′ amount of active element L, if M′>N′, then site N has a lower degree of potency causing harm to its surroundings, or it is less polluting.

“Treatment” of a polluted site or material, or decontamination can be done either on site (in-situ) or off site (ex-situ) or combination of both depending on scale of treatment, location of the sites, and ultimate goal of the treatment. In-situ treatment has typically lower cost than ex-situ treatment but also reduce potential pollution caused by relocation and transportation of the polluted materials. However, in some cases, due to availability of treatment establishment or facility at off-site location, difficulties in setting up treatment facility on-site or due to lack of scale-of-economics on-site, off-site treatment is a better option.

“Encapsulating agent” refers to a material whose addition to the contaminated samples can lead to coverage of the surface of the contaminated particles or particles that have association with the contaminants. The degree of coverage or thickness of the coverage varies. The thicker and denser the coating layer the less likely the contaminants could leach out, or to be extracted, or to be released.

There are a number of mechanisms a coating layer is initiated and accomplished. They include: (1) electrostatic interaction; (2) surface adsorption; (3) hydrogen bonding. FIG. 1 is the schematics of (A) electrostatic interaction; and (B) non-electrostatic interaction. Sediment particles are typically negatively charged in aqueous suspension or slurry unless the pH of the suspension or slurry is adjusted to high acidity. Likewise, many contaminants are negatively charged as well in aqueous system. Under this circumstance, addition of a positively charge particles can lead to deposition of the positive particles on the pollutant bearing particles due to Columbic attraction. For a strong coating layer, the coating particles should be substantially smaller than the size the particle to be coated.

“Zeta potential” or surface charge of a particle surface acquired in a suspension or slurry is a measurement of double layer, also called Stern layer, or Stern potential. It is a property of surface as a result of (1) ionization of the surface species in a medium, (2) selective ion adsorption. Medium includes,, water, polar solvent, for example, heteroatom containing compounds, oxygenates, amines, sulfides, non-polar solvent, for example, hydrocarbons. Ionics include, metal cations, K⁺, Ca²⁺, Fe²⁺, Fe³⁺, Al³⁺, cationic polymers, for example, aluminum 13-mer, Cat Floc 8108+, Superfloc C-277; inorganic anions, NO₃⁻, CO₃²⁻, SO₄²⁻, PO₄³⁻, HPO₄²⁻, Cl⁻, F⁻, ClO₄⁻, S²⁻, Mo₂O₇²⁻, SiO₄²⁻, organic anions, HCOO⁻, CH₃COO⁻, oxalic anion, citric anion sulfonics, polyoxyethylenated fatty alcohol carboxylates, ligninsulfonates, petroleum sulfonates, N-Acyl-n-alkylataurates, sulfosuccinate esters, phosphoric and polyphosphoric acid esters, fluorinated anionics.

Zeta potential can be measured using well known techniques like electrokinetic method, acoustic and electro-acoustic method, and electrophoretic light scattering method. Widely used instruments include, Brookhaven Instruments' ZetaPals, Zeta Plus; Matec Instruments' AZR-Plus; Dispersion Technology's DT-1200; Malvern Instruments ZetaSizer and NanSizer; Beckman Coulter Instruments' Delsa Zeta Potential Analyzer.

“Isoelectric point (IEP) or point of zero charge (PZC)” is a surface characteristics of charged particle in the presence of medium. In aqueous systems, the PZC or IEP is the pH where the surface charge is zero, or surface potential is zero, or electric mobility of the particle is zero. The PZC is the more fundamental double layer property, but cannot be determined experimentally (J-E. Otterstedt and D. A. Brandreth, “Small Particles Technology, Chapter 6, Plenum Press, New York, 1998). Instead, the IEP is used to study and characterize the stability, separation, recovery, or removal of small particles, for example, flocculation and aggregation behavior of colloidal systems. It can be determined by measuring the electric mobility as a function of pH when small monovalent cations are adsorbed on the particles. In addition to electrokinetics, acoustic and electro-acoustic spectroscopy methods, other methods, i.e., flocculation and settling measurement, adsorption measurements can also be used to determine IEP. General description and examples can be found in Chapter 3 of “Chemical Properties of Materials Surfaces”, by M. Kosmulski, Marcel Dekker, New York, 2001.

Generally speaking IEP of particles vary between 2 to 12. However, some particles do not have an IEP except at extreme acidic or basic conditions. Table 2 provides general zeta potential behavior of metal oxides. Alkali, and alkaline earth metal oxides tend to be positively charged at or near neutral pH whereas high multivalent metal oxides, dioxides and trioxides tend to be negatively charged at neutral pH.

It needs to be emphasized that surface charge or zeta potential of a particle is a surface characteristics. It is highly influenced by or dependent on the environment the particle is in, that is the medium, presence of ionics, and non-ionics, concentration of ionics and non-ionics. Due to this unique nature, zeta potential measurement and IEP determination is a highly sensitive measurement of presence of low levels of impurity, small perturbation of process conditions. As low as a few or a few tens ppm of impurity can lead to significant change in zeta potential. The consequences can be quite dramatic. For example, an otherwise stable system, can turn into precipitation due to perturbation of process conditions leading to near IEP or passing IEP, that is charge reversal from positive to negative or the other way around. At IEP, due to lack of electrostatic repulsion, particles collide or attract to each other result in agglomeration, subsequently, leading to formation of large particles or flocs that settle or precipitate out under gravity. FIG. 2 illustrates a typical zeta potential curve and IEP.

Adsorption of anions deceases the IEP because more protons or acids are required to neutralize the negative charge of the anions adsorbed on the surface. Furthermore, multivalent anions lower IEP much more than monovalent anion. Likewise, adsorption of cations increase the IEP. Adsorbed metal cations cause the IEP to shift toward the IEP of the hydrous oxide of the metal making up the cation.

In one embodiment, the size ratio of coating particle to pollutant bearing particle should be less unity, more preferably, less than 0.5, even more preferably less than 0.2. In other words, for a contaminant particle of 1 micron, the size of the coating particle should be smaller than 1 micron, more preferably smaller than 0.5 micron, even more preferably smaller than 0.2 micron.

To achieve fast deposition, the charge density (number of charge units per molecule or per particle) of the coating particles should be significantly greater than 0.001 meq/g, more preferably, greater than 0.002 meq/g, and even more preferably greater than 0.003 meq/g. Coating particles are selected from but not limited to colloidal basic aluminum chloride, aluminum chlorohydrate, colloidal alumina, colloidal ceria, colloidal zirconia. Properties of selected cationic coating particles or cationic polymer modifiers are provided in Table 3.

Alternatively, the pollutant bearing particle surface can be modified to acquire a charge so that the opposite charge coating particles can be deposited on the modified particles. To make the pollutant bearing particles negatively charged or more negatively charged, anionic additives can be used. They can be organic or inorganic. A selected number of anionics are given in Table 3.

For selective adsorption and hydrogen bonding, surface modifiers can be selected from hydrogen bonding agents. Organic hydrogen bonding agents are listed in Table 4. The relative effectiveness of hydrogen-bonding agents is defined based on dimethoxytetraethylene glycol as 100, that is, if the amount of substance whose effectiveness is such that twice as much as required as that of the standard, then it's effectiveness is 50, likewise, if only one half the amount of the standard is needed to achieve the same effect, then this substance has an effectiveness 200. Other organic hydrogen bonding include, polymerics organic oxygenates, for instance, polyvinylalcohol (PVA), or heteroatom containing compounds, for instance, polyvinyl pyrollidone (PVP), and tertiary amines.

“Stabilizing agent” added to the sediment slurry during mixing and milling reacts with pollutants to form a less reactive form of pollutants. Stabilizing agents can be selected from sulfur containing compounds or materials, for example, metal sulfides, metal hydrogen sulfides, disulfides, elemental sulfur, or sublime sulfur, metal oxides, nature or synthetic clay, natural or synthetic zeolites, carbon blacks, charcoals, fine particles of refractory materials, spent or shredded tire, spent or recycled polymer materials or composite, cement powder, limestone, lime, gypsum, sea shells, fly ash, or residue or byproducts from many manufacturing processes.

In one embodiment, decontamination is achieved by reacting active polluting form with a stabilizing agent to convert the active polluting form into an inactive form. One example is an extractable form of mercury or soluble form of mercury is converted into non-extractable or less-extractable mercury form or low solubility form. More specifically, Hg²⁺ reacting with a sulfide source to give HgS which has very low solubility.

Most commonly encountered metal sulfides, MₓS_{y}, where M is metal, S is sulfide, in sediments or that are relevant to sediment decontamination, typically have a low IEP as presented in Table 5. This means that except at very low pH, close to pH 3 or so or highly acidic condition, metal sulfide particles carry a negative charge in aqueous suspensions or slurries. Therefore, by applying a cationic encapsulation agent, it can lead to electrostatic encapsulation, or hydrogen bonding component to achieve hydrogen bonding induced encapsulation of the pollutant particles.

The IEP of metal sulfides may differ from that of those commonly encountered components present in sediments and soils. By utilizing the IEP differences, one can achieve selective encapsulation of toxic metal sulfides, MₓS_{y}, while leaving other component alone or less covered, thus, leading to major reduction in the amount of encapsulating agent required to achieve high decontamination efficiency.

Pollutants in sediments can be present in many different forms, ranging from solid particles of extractable form, ionic species adsorbed on surfaces or pores of particles, soluble form in water that is associated with the sediments. Due to this heterogeneity in form and wide variation in particles size, ranging from colloid particles to micron sized particles or larger particles in tens to hundreds of microns, to achieve complete conversion or reaction can be a real challenge. Any incomplete conversion or transformation would result in lower decontamination efficiency. Therefore, to achieve high decontamination efficiency, a thorough and complete homogenization is required.

From reaction kinetics point of view, for a given particle, reaction between pollutant and stabilizing agent occurs first at the outer layer, then progresses into the interior. Pollutant present inside a large particle would require a longer reaction time to be converted to an inactive form since the stabilizing agent has to penetrate through the outer layer. Transportation or diffusion of reactant through a solid layer meets with high resistance, making it very difficult to achieve high decontamination efficiency for large contamination particles. Therefore, it is critical to have smaller particle size to achieve high treatment efficiency.

Reduction in particle size not only enables higher degree of decontamination but also make treatment possible for many process that otherwise taking an unrealistically long time to treat.

“Slurry or suspension” is referred to a mixture of polluted sediments and a dispersing agent, for example, water, and stabilizing agent or other additives to form a suspension or slurry. The water introduced can be fresh water, or water co-present in the pollution site or other waste water stream.

“Solids content” of the slurry or suspension is defined as the amount of solids particles or residue left after a treatment at elevated temperature to drive off water, or any other volatiles, or combustion to burn off organics. For example, treatment of sediment sample at 550° C. for 2 hours in air resulted in a residue whose mass is 40% of the original mass, that is the solids content of this sediment sample is 40 wt %. The solids content is collection of sediment particles, and other introduced materials for example stabilizing agents or additives that are not removed at 550° C. in air.

“Dispersant or dispersion aid or surface modifier” refers to a class of components or chemicals that their addition in a small amount to a slurry or suspension can result in a significant improvement in dispersion, that is (1) increased rate of breakdown of large lumps, (2) better wetting of dry particles or powder introduced into the slurry or suspension; (3) reduced viscosity. These changes or improvements are closely related to alteration in surface properties, surface charge, charge density or zeta potential. A detail list of different types of surface modifier or surfactants can be found in “Surfactants and Interfacial Phenomena”, Chapter 1, 3^{rd} Edition, by M. J. Rosen, John Wiley & Sons, Hoboken, N.J., 2004.

Surface charge or zeta potential of a particle can be altered by-a number of means. The most commonly practiced ones include water soluble ionics. Their presence or adsorption leads to major change in surface charge. Introduction of certain metal cations or anions into the treated system may lead to toxicity, thus, are less preferred than those that are non-toxic or less toxic. There are three types of water soluble organic ionics: (1) cationic; (2) anionic; and (3) zwitterionic.

Zwitterionics contain both an anionic and a cationic charge under normal conditions, for example molecules containing a quaternary ammonium as the cationic group and a carboxylic group. For ionic surface modifiers the higher the charge density the more effective in surface modification. For example, according to Patton (T. C. Patton, Paint Flow and Pigment Dispersion-A Rheological Approach to Coating and Ink Technology, 2nd Edition, John Wiley & Sons, New York, p. 270, 1979), efficacy of cations or anions in surface modification increased from monovalent to divalent to trivalent in a ratio of 1:64:729.

Non-ionic surface modifiers are polyelthylene oxide, polyacrylamide (PAM), partially hydrolyzed polyacrylamide (HPAM), and dextran.

Anionic surface modifiers include, carboxylate, sulfate, sulfonate and phasphate. Examples of water soluble anionic polymer are: dextran sulfates, high molecular weight ligninsulfonates prepared by a condensation reaction of formaldehyde with ligninsulfonates, and polyacrylamide. Commercially available anionic water soluble polymers include polyacrylamide, CYANAMER series from Cytec Industries Inc., West Paterson, N.J., like, A-370M/2370, P-35/P-70, P-80, P-94, F-100L & A-15; CYANAFLOC 310L, CYANAFLOC 165S.

Cationic surface modifiers: The vast majority of cationic polymers are based on the nitrogen atom carrying the cationic charge. Both amine and quaternary ammonium-based products are common. The amines only function as an effective surface modifier in the protonated state; therefore, they cannot be used at high pH. Quaternary ammonium compounds, on the other hand, are not pH sensitive. Ethoxylated amines possess properties characteristic of both cationic and non-ionics depending on chain length. Examples of water soluble cationic polymers are: polyethyleneimine, polyacrylamide-co-trimethylammonium ethyl methyl acrylate chloride (PTAMC), and poly(N-methyl-4-vinylpyridinium iodide. Commercially available materials include: Cat Floc 8108 Plus, 8102 Plus, 8103 Plus, from Nalco Chemicals, Sugar Land, Tex.; polyamines, Superfloc C500 series from Cytec Industries Inc., West Paterson, N.J., including C-521, C-567, C-572, C-573, C-577, and C-578 of different molecular weight; poly diallyl, dimethyl, ammonium chloride (poly DADMAC) C-500 series, C-587, C-591, C-592, and C-595 of varying molecular weight and charge density, and low molecular weight and high charge density C-501.

Zwitterionics: Common types of zwitterionic compounds include N-alkyl derivatives of simple amino acids, such as glycine (NH₂CH₂COOH), amino propionic acid (NH₂CH₂CH₂COOH) or polymers containing such structure segments or functional group.

“Solidification agent” refers to a chemical or substance that its introduction to a slurry or suspension can lead to hardening of the slurry or suspension, or can result in significant reduction in time required to achieve hardening or solidification. Typical solidification agent includes but not limited to cement, for example, Portland cement, cement clinker, gypsum, metakaolin, and other binder materials.

Solidification is desired in certain treatment scenarios because it can lead to a treated solid product in a short period of time.

A highly recognized utility of solidification is its ability to form a barrier to separate pollutants and the surroundings where the solidification is carried out. If applied correctly, especially in ample amount, it is possible to achieve encapsulation of pollutants.

Encapsulation of pollutants by a solidification agent has the potential to substantially reduce pollution if the encapsulation layer is dense and free of cracks making transportation of pollutant very slow. However, potential risk associated with breakdown of the barrier layer or developing cracks or holes in the barrier layer remains high if the pollutants are simply contained not treated.

In one embodiment, solids content of the slurry to be treated by milling is at least 1 wt %. It is more preferred the solids content is at least 2 wt %. It is even more preferred the solids content is at least 3 wt %, and it is most preferred that the solids content is at least 5 wt %.

Known milling techniques include but not limited to ball milling, roller milling, sonication, high-shear milling, and medium milling.

In one embodiment, milling is achieved by using a high-shear mixer or mill or a medium mill or mixer or combination of both.

It is preferred that after milling particle size d₅₀ or average particle size is reduced by at least 10% from for example 20 microns to 18 microns. It is even more preferred that after milling, d₅₀ is reduced by at least 15% from for example 20 microns to 17 microns. It is most preferred that after milling d₅₀ is reduced by at least 20% from for example 20 microns to 16 microns.

It is recognized that to maximize milling throughput and efficiency a high solids content slurry is desired. However, it is also recognized that slurries having high solids content often encounter high viscosity making them difficult to homogenize, difficult to transport and even more difficult to be milled. Therefore, it is highly desired to have a process that is capable of handling high solids content slurries.

In one embodiment, transportation means that can handle high solids materials, for example, positive displacement pump is used to carry out slurry transportation from the mixing tank to the mill, for example, Moyno 1000 pump from Moyno Inc., Springfield, Ohio.

In one embodiment, a modifier is added to the slurry so that slurry viscosity can be significantly reduced. It is preferred that the surface modifier added can lead to reduction in slurry viscosity by at least 5%, that is from for example 50,000 cps to 47,500 cps, more preferred by at least 10%, that is from for example 50,000 cps to 45,000 cps, and most preferred by at least 15%, at is from for example 50,000 cps to 42,500 cps.

In one embodiment, the modifier is an ionic additive or water soluble polymer or dispersing regent selected from inorganic acids, low molecular weight organic acids, polyacids, cationic and anionic water soluble polymers.

In another embodiment, the amount of stabilizing agent added is at least 20 parts per million by weight (wt ppm). It is more preferred that the amount is at least 30 ppm. It is most preferred that the amount is at least 35 ppm.

In yet another embodiment, upon stabilization treatment, the active pollutant form is reduced by at least 5%, more preferred by at least 10%, and most preferred by at least 15%. In other words, the active pollution form is reduced from 5 ppm to 4.75 ppm, or from 5 ppm to 4.5 ppm or from 5 ppm to 4.25 ppm respectively.

### EXAMPLES

### Example-1 (Comparison)

A mud sample collected at the Hangu Reservoir, Tianjin, China was used for evaluation of efficacy of decontamination. This sample was collected at the location where sediment accumulation was approximately 20-25 inches in thickness. It is 250 feet away from the inlet of the reservoir and is east of the inlet. The inlet of the reservoir is at the north end. This location is classified as pollution level of high. The sample was collected using a device that does not lead to any significant disturbance to the sample surrounding while maintaining the overall integrity of the sample, i.e., solids and the liquid retained. Solid content of the mud sample was determined using a muffle furnace. The sample was treated at 550° C. for 2 hours before it was cooled down and weighed for weight loss. An amount of 20 grams sample was used for solid content determination. This sample has a solids content of 46.5 %. This sample was diluted using 0.001 M KCl solution to a concentration of 0.25 mg/ml of solution for zeta potential measurement using the Brookhaven ZetaPals instrument from Brookhaven Instruments Corp., Holtsville, N.Y. pH of the diluted sample was adjusted to higher using a sodium hydroxide solution having pH of 14 or adjusted lower by using a hydrochloric acid solution having pH of 2 to get a zeta potential versus pH curve to determine isoelectric point (IEP). This sample did not show an IEP in the pH range from 2.7 to 8.7 (FIG. 3). The mud particles carried negative charge throughout the pH range investigated.

### Example-2 (Invention)

The mud sample from Example-1 was used for treatment. It was first made into a slurry by adding distilled water to the mud sample according to: 600 grams of mud, 236 grams of distilled water while under mixing with a spatula in large polypropylene container to give a uniform slurry. An aluminum chlorohydrate solution (solid content: 26.2 wt %) from Shanghai Domen International Chemical Company, Shanghai, China, was added to the mud slurry while under constant mixing using a spatula. It resulted in a thick slurry. This slurry was diluted using a 0.001 M KCl solution according to the same protocol as Example-1 for zeta potential measurement. This sample has an IEP of 9.6 (FIG. 4). It has an ACH to mud solid mass ratio of (200*26.2%)/(600*46.5%)=0.188.

### Example-3 (Invention)

The mud sample from Example-1 was used for treatment. A diluted aluminum chlorohydrate solution was made by using the aluminum chlorohydrate (ACH) solution (50% ACH) from Shanghai Domen International Chemical Company, Shanghai, China, according to: 200 grams of ACH solution mixed with 236 g of distilled water while under mixing with a spatula in large polypropylene container to give a uniform slurry. An amount of 120.8 grams of the mud sample from Example-1 was added to the diluted ACH solution. This led to a semi-solid mixture. This sample was diluted using a 0.001 M KCl solution according to the same protocol in Example-I for zeta potential measurement. This sample has an IEP of 10.9 (FIG. 5). It has an ACH to mud solid ratio of (200*26.2%)/(120.8*46.5%)=0.933.

### Example-4 (Invention)

The mud sample from Example-1 was used for treatment. A diluted aluminum chlorohydrate solution was made by using the aluminum chlorohydrate (ACH) solution (50% ACH) from Shanghai Domen International Chemical Company, Shanghai, China, according to: 100 grams of ACH solution mixed with 336 grams of distilled water while under mixing with a spatula in a large polypropylene container to give a uniform slurry. An amount of 227.4 grams of the mud sample from Example-1 was added to the diluted ACH solution. This led to a semi-solid mixture. This sample was diluted using a 0.001 M KCl solution according to the same protocol in Example-1 for zeta potential measurement. This sample has an IEP of 10.2 (FIG. 6). It has an ACH to mud solid mass ratio of (100*26.2%)/(227.4*46.5%)=0.248.

### Example-5 (Invention)

The mud sample from Example-1 was used for treatment. A diluted aluminum chlorohydrate solution was made by using the aluminum chlorohydrate (ACH) solution (50% ACH) from Shanghai Domen International Chemical Company, Shanghai, China, according to: 50 grams of ACH solution mixed with 386 grams of distilled water while under mixing with a spatula in a large polypropylene container to give a uniform slurry. An amount of 200 grams of the mud sample from Example-1 was added to the diluted ACH solution. This led to a pasty mixture. This sample was diluted using a 0.001 M KCl solution according to the same protocol in Example-I for zeta potential measurement. This sample has an IEP of 2.6 (FIG. 7). It has an ACH to mud solid mass ratio of (50*26.2%)/(200*46.5%)=0.141.

### Example-6 (Invention)

The sample from Example-5 was milled using an Eiger Mini 250 mill at 3600 RPM and 1.00 mm zirconia microspheres from Tosoh. After milled for one pass, the slurry has a viscosity shown FIG. 8, having a shear thinning behavior. This sample was diluted using a 0.001 M KCl solution according to the same protocol in Example-1 for zeta potential measurement. This sample has an IEP of 3.8 (FIG. 7). It has an ACH to mud solid mass ratio of (50*26.2%)/(200*46.5%)=0.141. Viscosity of the milled slurry is shown in FIG. 8. The slurry shows a strong shear thinning behavior.

To those skilled in the art that if a charged particle or article having negative charge or negative zeta potential becomes positive charge in the presence of positively charged particles, the said negatively charged particle is now covered or encapsulated by the positively charged particles. In other words, a successful encapsulation has achieved for the former particle.

From Examples 1, one can conclude that the mud particles are negatively charged in the entire pH range investigated, i.e., 2-12. When a positively charged aluminum chlorohydrate (ACH) is introduced into the mud formulation, its zeta potential is positive at pH below 9.6 as shown in Example-2. It is obvious that negatively charged mud sediment particles (Example-1) have been fully covered or encapsulated by the cationic inorganic binder, aluminum chlorohydrate (ACH).

It is further illustrated (Example-2 to Example-5) that depending on the amount of ACH added, surface coverage or zeta potential varies. The results are presented in Table 6. The higher the ACH to mud solid mass ratio, the higher the IEP. A near step-change occurred at ACH to mud mass ratio greater than 0.141.

It is further illustrated (Example-5 and Example-6) that a milling step can lead to significantly improvement in surface coverage or encapsulation.

Without wishing to be bound by any particular theory, it is clear to those skilled in the art that complete surface encapsulation of one type of particle by another type of particle through surface charge interaction or modification has been accomplished.

To those skilled in the art, particles with no or near zero zeta potential can also be covered by a charged through surface interaction via chemical bonding, selective adsorption or chemisorption.

Furthermore, multiple layers can be deposited by alternating coating layer charge or degree of charge, for example, a negatively charge particle can be covered first using a positively charged particles, followed with a layer of negatively charged particle on the first coating layer.

TABLE 1
Extraction Procedure for Leaching Toxicity

| Parameter of Methodoloty | Code or Specification |
|---|---|
| Procedure | HJ/T299-2007 (Chinese Burea of |
| | Environmental Protection) |
| Extract Solvent | Diluted sulfuric acid and nitric acid |
| | at weight ratio of 2 to 1 in solvent |
| | grade purified water having |
| | pH = 3.20 ± 0.05 |
| Sample Quantity | 40-50 grams |
| Sample Particle Size | <9.5 mm |
| Solvent/Solid Ratio | 10 L/kg |
| Extraction Temperature | 23 ± 2° C. |
| Duration of Extraction | 18 ± 2 hrs |
| Sample Shaking | 30 ± 2 RPM |
| Sample Storage Temperature | 4° C. |

TABLE 2
IEP of Metal Oxides

| Metal Oxide | IEP |
|---|---|
| M₂O | >11.5 |
| MO | >8.5, <12.5 |
| M₂O₃ | >6.5, <10.5 |
| MO₂ | >0, <7.5 |
| M₂O₅ | <0.5 |
| MO₃ | <0.5 |

TABLE 3
List of Ionics for Treating and Coating Contaminant Particles or Sediment Particles

| | | | | Charge |
|---|---|---|---|---|
| | | Particle | Cationinicity | Density |
| Ionics | Molecular Weight | Size (nm) | (%) | (meq/g) |
| Basic Aluminum Salts | 200-2,000 | 1-100 | <54 | 5.20 |
| Aluminum Chlorohydrates (ACH) | 100,10,000 | 1-200 | <25 | 3.00 |
| Nyacol Alumina Sol (AL20) | NA | 50 | >0.1 | >0.01 |
| Zirconia Sol | NA | 10 | >0.1 | >0.01 |
| Ceria Sol | NA | 20 | >0.1 | >0.01 |
| Polyacrylamide-A | 5,000,000 | NA | 2 | 0.25 |
| Polyacrylamide-B | 5,000,000 | NA | 25 | 3.00 |
| Polyethylene Imine (PEI) | 100,000-1,000,000 | NA | 20 | 2.50 |
| Polyethylene Amine (PEA) | 1,000,000 | NA | 20 | 2.50 |
| Cationic Starch | NA | NA | 0.4 | 0.25 |
| Nalco Cationic Starch | NA | NA | 0.08 | 0.10 |
| Cationic Polyacrylamide CPAM | NA | NA | 10 | 1.20 |
| Cationic Polyacrylamide CPAM | 5,800,000 | NA | 15 | 1.80 |
| Poly-dimethyldially ammonium | 1,200,000 | NA | NA | 6.19 |
| chloride (poly-DMDAAC) | | | | |
| Anionic Colloidal Silica-1 | NA | 3 | NA | 0.86 |
| Anionic Colloidal Silica-2 | NA | 3.3 | NA | 0.80 |
| Anionic Colloidal Silica-3 | NA | 3.1 | NA | 0.86 |
| Anionic Colloidal Silica-4 | NA | 4.4 | NA | 0.59 |
| Anionic Colloidal Silica-5 | NA | 5 | NA | 0.52 |
| Anionic Colloidal Silica-6 | NA | 5.4 | NA | 0.48 |
| Anionic Colloidal Silica-7 | NA | 10 | NA | 0.27 |
| Anionic Polyacryamide (A-PAM) | 1,000,000 | NA | NA | 0.15 |

TABLE 4
List of Hydrogen Bonding Agents and Their Effectiveness of Bonding

| | | Relative Molar |
|---|---|---|
| Type of Compounds | Compounds | Effectiveness |
| Standard | Dimethoxytetraethylene | 100 |
| | Glycol | |
| Ketones | Acetone | 17 |
| | Methyl Ethyl Ketone | 25 |
| Glycols | Ethylene Glycol | 0 |
| | Propylene Glycol | 7 |
| | 2-Methyl-1,2-butanediol | 18 |
| | Hexamethylene glycol | 27 |
| Alcohols | Ethanol | 3 |
| | Methanol | 6 |
| | Isopropanol | 11 |
| | t-Butanol | 16 |
| Amides | Formamide | 0 |
| | N,N-Dimethylformamide | 25 |
| | N,N-Diethylformamide | 40 |
| | Acetamide | 11 |
| | N,N-Dimethylacetamide | 41 |
| | N,N-Diethylacetamide | 54 |
| | N-Isobutylacetamide | 22 |
| | Urea | 7 |
| | Tetramethylurea | 44 |
| Primary Amines | Methylamine | 0 |
| | Cyclohexylamine | 25 |
| | 2-Ethylhexylamine | 32 |
| | m-Toluidine | 58 |
| Secondary Amines | Dimethylamine | 0 |
| | Diethylamine | 19 |
| | Piperidine | 38 |
| | Dibutylamine | 65 |
| | D9amylamine | 70 |
| Tertiary Amines | Trimethylamine | 14 |
| | Pyridine | 42 |
| | Quinoline | 66 |
| | Cyclohexyldiethylamine | 117 |
| Polyvinyl Alcohols (PVA) | Polyvinyl Ethanol | NA |
| Carboxylic Acids | Acetic Acid | NA |
| Pyrollidone | Polyvinylpyrollidone | NA |
| | (PVP) | |
| Acetates | Polyvinyl Acetate | NA |
| Hydrofuran | Tetrahydrofuran | NA |
| Organo phosphate | Triethyl phosphate | NA |
| Inorganic | H₂S, NH₃, HF, | NA |

TABLE 5
IEP of Selected Metal Sulfides and Sulfur

| Material | IEP |
|---|---|
| ZnS (synthetic) | 3 |
| CdS (synthetic) | 3.8 |
| PbS (synthetic) | 5 |
| HgS (synthetic) | 3.5 |
| NiS (synthetic) | <3 |
| FeS (synthetic) | 5.7 |
| CuS (synthetic) | <3 |
| As₂S₃(orpiment) | <3 |
| MoS₂ (synthetic) | <3 |
| S (synthetic) | <3 |

TABLE 6
IEP of Different Mud Formulations having Different
ACH/Mud Solid Mass Ratios

| | ACH/Mud | | |
|---|---|---|---|
| Example | Solid Mass Ratio | IEP | Comment |
| 1 | 0 | 2 or lower | Not Milled |
| 2 | 0.188 | 9.9 | Not Milled |
| 3 | 0.933 | 10.9 | Not Milled |
| 4 | 0.248 | 10.2 | Not Milled |
| 5 | 0.141 | 2.6 | Not Milled |
| 6 | 0.141 | 3.8 | Milled |

### DESCRIPTION OF FIGURES

FIG. 1 Illustration of encapsulation of pollutant particles: (A) electrostatic interaction; (B) non-electrostatic interaction. Formation of a coating layer consisting of small charged particles covering an appositively charged larger particle due to coloumbic interation in the case of (A) or non-electrostatic interaction in the case of (B). The coating layer acts as a barrier to prevent or to reduce material transfer from the inner particle to the outside, thus, dramatically reduced release of pollutants from the inner particle.

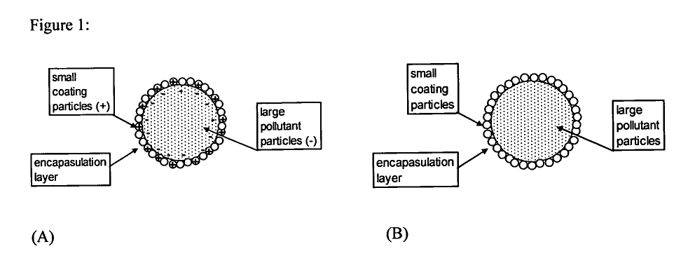

FIG. 2 Schematics of typical zeta potential curve showing curve shape, IEP. Zeta potential of a given material exhibits reverse “S” shape, the point crossing the zero charge is called is-oelectric point (IEP). Below IEP, the surface is positively charged, the lower the system pH the higher the positive charge. Likewise, above the IEP, the higher the pH the more negative is the surface charge. Typically, the absolute value of the surface is <120 mV, mostly <100 mV.

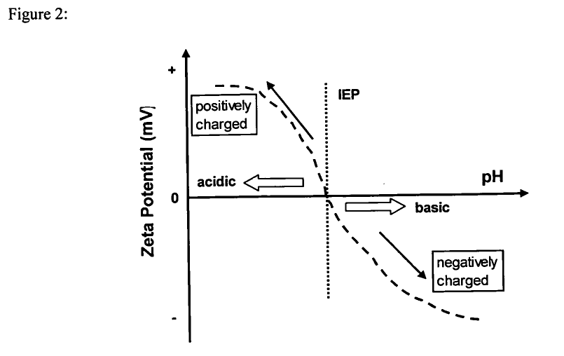

FIG. 3 Zeta potential curve of mud sample of Example-1. These mud particles carry negative charge from pH of 2.5 or higher. It does not appear to be an IEP, unless it gets highly acidic. Under typical practical pH conditions, their surface is always negatively charged. The negative charge does not seem change much as pH varies between pH of 2.5 to 9.

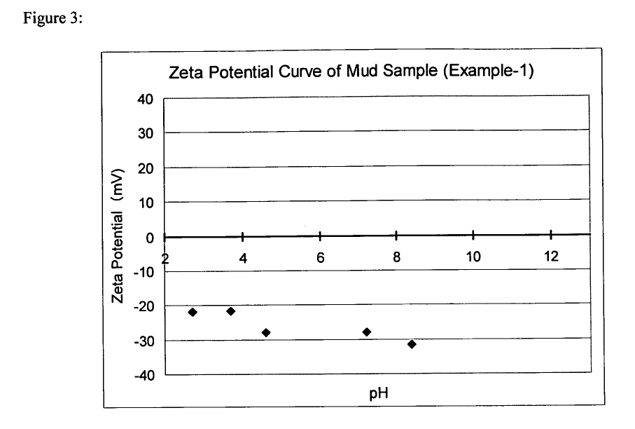

FIG. 4 Zeta potential curve of Sample Example-2: mud formulation with ACH/mud solid mass ratio of 0.188 not milled. When ACH is added to the mud used in FIG. 3, now it has an IEP of 9.6. This is achieved at ACH to mud solid mass ration of 0.188. Now, introduction of ACH has resulted in complete reversal of the surface charge from negative to positive at pH between 2.5 to <9.6. ACH is an effective surface charge modifier.

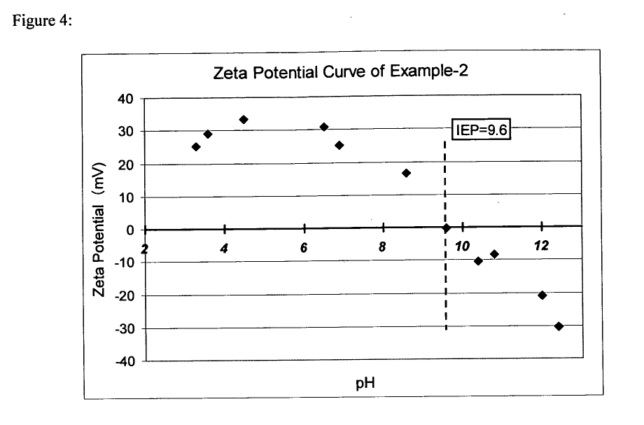

FIG. 5 Zeta potential curve of Sample Example-3: mud formulation with ACH/mud solid mass ratio of 0.933 not milled. Similar to that of FIG. 4, a higher ACH to mud mass ratio has led to further increase in IEP, that is, now, the surface becomes more positively charged. ACH is truly a cationic surface charge modifier.

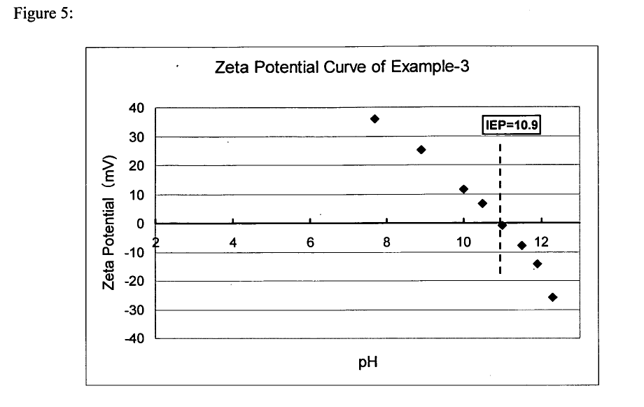

FIG. 6 Zeta potential curve of Sample Example-4: mud formulation with ACH/mud solid mass ratio of 0.248 not milled. Even at this moderately increased ACH to mud solid mass ratio, the IEP is appreciably higher than the lower ACH to mud mass ratio attained in FIG. 4.

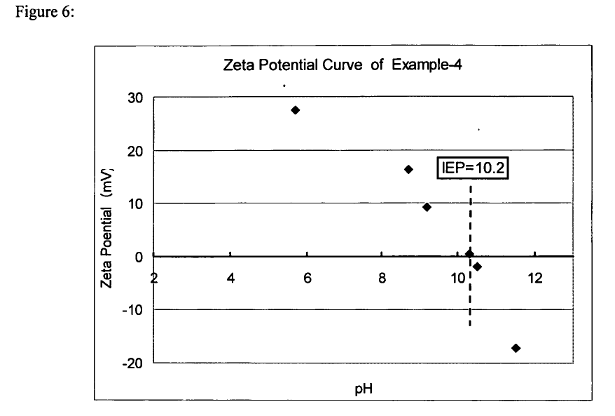

FIG. 7 Zeta potential curve of formulated mud samples of Example-5 and Example-6: ACH/mud solid mass ratio of 0. 141 before and after milling. At a very ACH to mud mass ratio, IEP of the mixture is closer to that of the mud sample, but it still shows a higher IEP, a clear impact by the cationic ACH. When this mixture is milled the IEP is increased by more one pH unit from 2.6 to 3.8, a strong indication of redistribution of the ACH, enabling more ACH to cover the surface of the mud particles. Milling is essential to achieve higher coating efficiency.

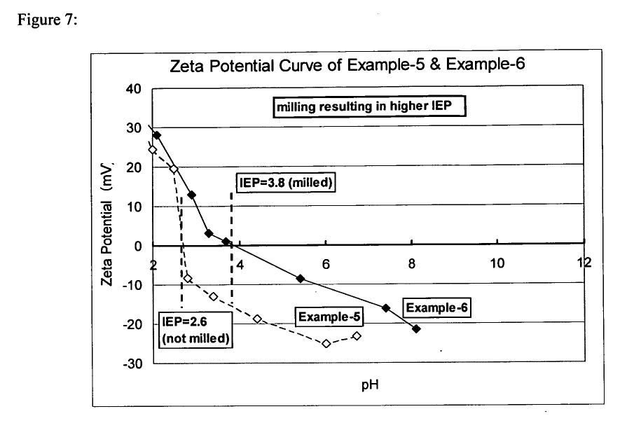

FIG. 8 Viscosity of formulated mud samples of Example-6 (milled): viscosity measurement using a Brookfield DV-II and #5 spindle at 19° C. The milled slurry from Example-6 shows strong shear-thinning behavior. It also has a high viscosity, over 10,000 cPs at 10 RPM. For typical industrial processing, a viscosity of 2,500-6,500 cPs at 10 RPM is the norm or high norm. Above 10,000 cPs is regarded as highly viscous and difficult to handle on a routine basis.

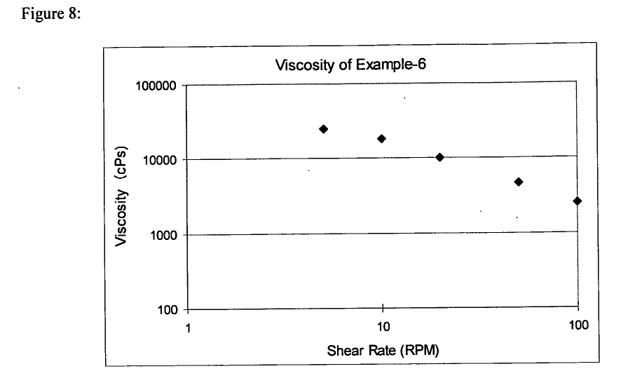

### REFERENCES

1. J-E. Otterstedt and D. A. Brandreth, “Small Particles Technology”, Plenum Press, New York, p. 8, 1998.
2. R. L. Xu, “Particle Characterization: Light Scattering Method”, Kluwer Academic Publisher, Dordrecht, The Netherlands,pp. 1-24, 2000.
3. P. A. Webb and C. Orr, “Analytical Methods in Fine Particle Technology”, Micromeritics Instrument Corp., Norcross, pp. 17-28, GA, 1997.
4. A. M. Spasic and J-P. Hsu, “Finely Dispersed Particles: Micro-, Nano-, and Atto-Engineering”, Taylor & Francis, Roca Raton, pp. 326-340, 2006.
5. M. Kosmulski, “Chemical Properties of Materials Surfaces”, Chapter 3, Marcel Dekker, N.Y., 2001.
6. M. J. Rosen, “Surfactants and Interfacial Phenomena”, Chapter 1, 3^{rd} Edition, John Wiley & Sons, Hoboken, N.J., 2004.
7. T. C. Patton, “Paint Flow and Pigment Dispersion: A Rheological Approach to Coating and Ink Technology”, 2^{nd} Edition, John Wiley & Sons, New York, pp. 1-13, pp. 270-271, 1979.

We claim:

1. A composition of particle comprising a first particle covered or encapsulated by a second particle:
(a) the first particle is selected from the group of sediment, polluted soil, solid removed from a chemical process, a production site, a polluted site, a mining site, a manufacturing site;
(b) the second particle is selected from the group of colloids, cationic colloidal particles, metal oxides, nano-particles of oxides, clays, zeolites, molecular sieves, active carbon or carbon black, byproduct from a chemical process or manufacturing step.

2. The composition of claim 1, wherein the first particle may carry a surface charge in an aqueous medium.

3. The composition of claim 1, wherein the second particle may carry a surface charge in an aqueous medium.

4. The composition of claim 1, wherein the surface charge measured as zeta potential of the second particle may be different from that of the first particle.

5. The composition of claim 1, wherein the second particle deposits on the surface of the first particle via electrostatic interaction.

6. The composition of claim 1, wherein the introduction of the second particle has led to a change of IEP by at least 0.1 pH unit.

7. The composition of claim 1, wherein additional layers can be deposited on top of the second particle deposits on the surface of the first particle via electrostatic interaction.

8. The composition of claim 1, wherein the first particle has a first median particle diameter of at least about 0.01 microns.

9. The composition of claim 1, wherein the second particle has a second median particle diameter of at most 10 microns.

10. The composition of claim 1, wherein the solid mass ratio of-second particle to first particle is at least 0.001.

11. The composition of claim 1, wherein the solid content of mixture containing the first particle, the second particle and optionally the third particles or more particles, and a dispersing medium has a solid content of at least 0.01 wt % and at most 85 wt %.

12. A process of making a particle comprising a first particle covered or encapsulated by a second particle:
(a) the first particle is selected from the group of sediment, polluted soil, solid removed from a chemical process, a production site, a polluted site, a mining site, a manufacturing site;
(b) the second particle is selected from the group of colloids, cationic colloidal particles, metal oxides, nano-particles of oxides, clays, zeolites, molecular sieves, active carbon or carbon black, byproduct from a chemical process or manufacturing step.

13. The process of claim 12, wherein introduction of the second particle has led to coverage or encapsulation characterized by a shift of IEP of the first particle in the presence of second particle by at least 0.1 pH unit.

14. The process of claim 12, wherein a mixing step is used to achieve inter-particle mixing.

15. The process of claim 12, wherein a mixing step uses a mixer selected from the group of high-shear mixers, bead mills, medium mills, colloid mills.

16. The process of claim 12, wherein introduction of the second particle has led to a change in IEP of the first particle by at least 0.1 pH unit.

17. The process of claim 12, wherein mixing and milling has led to improvement in surface coverage or encapsulation characterized by a shift of IEP of the first particle in the presence of second particle by at least 0.1 pH unit.

18. The process of claim 12, wherein the solids content of the mixture of the first particle, the second particle, optionally the third or additional particles, and a dispersing medium is at least 0.01 wt % and at most 85 wt %.

19. The process of making a mixture comprising a first particle, the second particle, optionally the third and additional particles, and a dispersing medium following the sequence of:
(a) the first particle is first introduced into the dispersing medium;
(b) mix or mill the above mixture
(c) the second particle is introduced into the mixed or milled first particle mixture
(d) addition surface modifier is introduce in any of the steps of (a) to (c)

20. A composition of claim 19 wherein the particle comprising a first particle and a second particle, optionally a third or additional particles:
(a) wherein the second particle has a charge density at least 0.001 meq./g;
(b) the second particle is selected from the group of basic aluminum salts, aluminum chlorohydrates, colloidal alumina sols, Nyacol alumina sol, zirconia sols, ceria sols, polyacrylamide, polyethylene imine, polyethylene amine, cationic starch, cationic polyacrylamide or combination of thereof.

21. A composition of claim 19 wherein the particle comprising a first particle and a second particle, optionally a third or additional particles:
(a) wherein the second particle is a hydrogen bonding agent;
(b) wherein the second particle has a relative effectiveness of hydrogen-bonding at least 2;
(c) wherein the second particle organic amines, alcohols, glycols, ketones, polyvinyl alcohols, pyrollidone, acetates, hydrofuran, organic phosphates, ammonia, hydrofluoric acid or combination of thereof.

22. A process of using of claim 19 to reduce active pollution components in the first particle by introducing the second particle, and optional third or addition particles:
(a) wherein the pollution components are from the group of heavy elements, including mercury, arsenic, selenium, chromium, manganese, nickel, cadmium but not limited to these elements;
(b) active form of polluting elements is reduced determined by an acid extract procedure for leaching toxicity;
(c) the first particle is from a sediment from a polluted sites.
